(19) United States
(12) Patent Application Publication
(10) Pub. No.: US 2009/0195184 A1
(43) Pub. Date: Aug. 6, 2009

(54) DRIVE CIRCUIT FOR DRIVING A LOAD WITH PULSED CURRENT

(75) Inventors: Roelf Van Der Wal, Oss (NL); Zadok Vitalis Socrates Kroeze, Oss (NL)

Correspondence Address: Philips Intellectual Property and Standards, P.O. Box 3001, Briarcliff Manor, NY, 10510-8001, US

(73) Assignee: KONINKLIJKE PHILIPS ELECTRONICS N.V., Eindhoven (NL)

(21) Appl. No.: 12/303,376

(22) PCT Filed: Jun. 20, 2007
(86) PCT No.: PCT/IB07/52387

§ 371 Date: Dec. 4, 2008

(30) Foreign Application Priority Data
Jun. 22, 2006 (EP) 06115869.7

(51) Int. Cl. H05B 37/02

(52) U.S. Cl. 315/294

(57) ABSTRACT

A drive circuit (1) for driving a load (3) comprises: a power supply (10) for supplying an output current (I_{L}); a controller (20) for controlling the power supply; a current sensor (25) for generating a current sense signal (V₂₅); a controllable switch (30) in series with the output (2a, 2b), the switch being controlled by a mode controller (50); wherein the mode controller in a reduced brightness mode generates its switch control signal (S_{LC}) for the switch for alternatively opening and closing the switch. At the end of a current pulse, an average current value averaged over the pulse duration is calculated, compared with a reference value (V_{REF}), and, if said average value is larger than the reference value, a duration for the next pulse pause is calculated such that an average value averaged over the entire pulse period is equal to the reference value.

### FIELD OF THE INVENTION

The present invention relates in general to a drive circuit for driving a load with pulsed current. More particularly, the present invention relates to a drive circuit comprising a switched mode power supply. The invention more particularly relates to driving a LED array, but the principles of the present invention can also be applied to other types of load.

### BACKGROUND OF THE INVENTION

LEDs are conventionally known as signalling devices, for instance an indicator that an apparatus is stand-by. With the development of high-power LEDs, LEDs are nowadays also used for illumination applications. In a particular application, a LED array is used in a tail light unit of a vehicle, specifically a motor vehicle. In such application, the LED array can have two different operational modes. In a first mode, the LEDs generate maximum light intensity. This is achieved by operating the LEDs continuously with nominal current (DC). In this mode, the LED array functions as brake light, so this mode is also referred to as “brake mode”. This brake mode is only active for as long as the vehicle driver actuates the brake pedal or brake handle.

In a second mode, the LEDs generate reduced light intensity. In this mode, the LED array functions as tail light, so this mode is also referred to as “tail mode”. Reducing the light intensity can be done by reducing the LED current. However, this is not preferred, because the color and efficiency of the LEDs may change if the current intensity changes. Therefore, reducing the light intensity is typically done by driving the LEDs with pulsed current, i.e. the current is alternatively zero or maximal (i.e. nominal). A time interval where the current is zero will be indicated as an OFF interval or pulse pause: during such interval, the LED is OFF. The duration of this interval will be indicated as OFF duration or pulse pause duration. A time interval where the current is nominal will be indicated as an ON interval or pulse: during such interval, the LED is ON. The duration of this interval will be indicated as ON duration or pulse duration. The average light intensity depends on the duty cycle, i.e. the ratio of the pulse duration (ON) to the duration of the pulse period (ON+OFF). A lamp driver is designed to keep the average light intensity constant by keeping the average current constant.

Driver circuits for driving an arrangement of LEDs with substantially constant current are already known. Typically, such constant current driver circuit comprises a current sensor for sensing the LED current, and a sensor signal is fed back to a controller, which controls a power source such that the sensed current is kept substantially constant at a predetermined level. The drive circuit further comprises a controllable switch connected in series with the lamp. In tail mode, the controller switches the switch OPEN and CLOSED alternatively. During the pulse intervals, the LED current is kept substantially at the nominal level; if current deviations occur, the influence on the average current is compensated by varying the duty cycle.

A problem may occur if the power source is a relatively slow power source. This problem typically may occur in case the power source is implemented as a converter, but the problem may also arise in the case of other types of power sources. In this respect, “slow” means that the time it takes for the power source to have its output current rise from zero to the nominal current level is longer than the pulse duration. During the pulse pause, the output current of the power source reduces, perhaps even drops back to zero, and at the start of the next pulse the current starts rising again. Thus, if the nominal level is reached at all, it may take many current periods until the LED current finally reaches this level, which means that the intensity of the tail lights reaches its operative level only very slowly.

The present invention aims to provide a drive circuit where this problem is overcome or at least reduced. More particularly, the present invention aims to provide a drive circuit which is capable of driving LEDs with pulsed current and which has improved start-up characteristics.

### SUMMARY OF THE INVENTION

According to an important aspect of the invention, the driver circuit calculates the average current intensity during the current pulses. If the average current intensity is less than nominal, the driver circuit reduces the pulse pause duration of the next pulse pause. Ideally, it is thus possible to have the average current intensity (averaged over the entire current period) reach its target value relatively fast, even if the power supply is relatively slow.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1 is a block diagram schematically showing a driver circuit;

FIG. 2 is a graph illustrating the operation of a power source;

FIG. 3 is a graph illustrating the switching of the lamp current;

FIGS. 4A and 4B are graphs illustrating a current in the power source as a function of time;

FIG. 5 is a graph illustrating the effect of the invention.

### DETAILED DESCRIPTION OF THE INVENTION

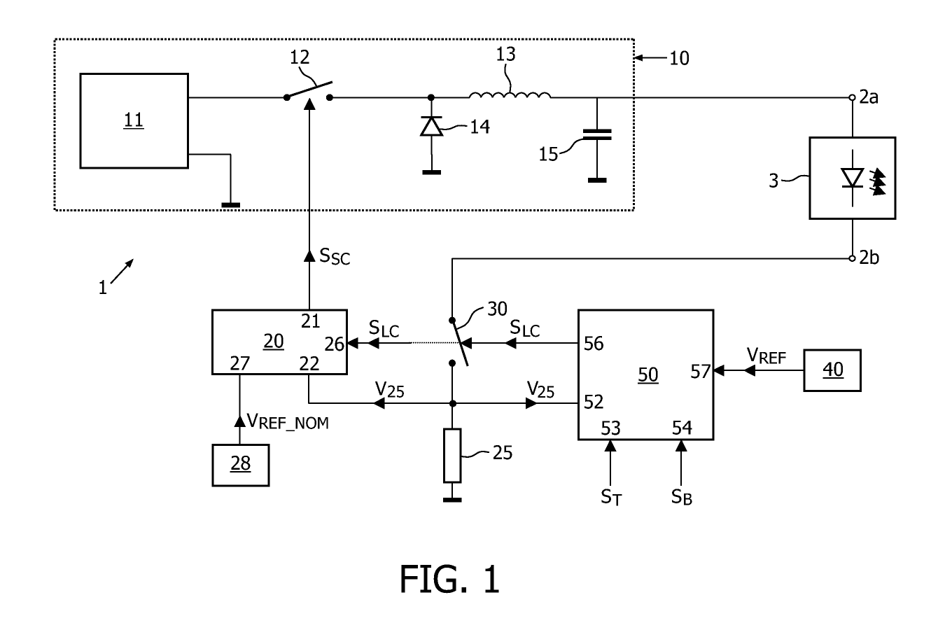

FIG. 1 is a block diagram schematically showing a driver circuit 1 having output terminals 2a, 2b for connection to a load 3. The driver circuit 1 further comprises a controllable switched mode power supply 10, and a supply controller 20 for controlling the power supply 10. It is noted that the principles of the invention can be applied to several types of load, but in the following it will be assumed that the load is a LED arrangement 3 comprising a plurality of LEDs arranged in series and/or in parallel, used as a rear light unit in a car.

Switched mode power supplies are known per se, therefore the description of the exemplary switched mode power supply 10 illustrated in FIG. 1 will be kept brief. Reference numeral 11 indicates a voltage source, such as a car battery. A controllable switch 12, for instance a transistor, is coupled to a first output terminal of the voltage source 11. An inductor 13, typically a coil, is coupled in series with the controllable switch 12. At the junction of the switch 12 and the inductor 13, a diode 14 is coupled to a second output terminal of the voltage source 11, while the opposite end of the inductor 13 is coupled to a first output terminal 2a of the driver circuit 1. A second output terminal 2b of the driver circuit 1 is coupled to the second output terminal of the voltage source 11. At the junction of the first output terminal 2a and the inductor 13, a capacitor 15 is coupled to the second output terminal of the voltage source 11.

The supply controller 20 has a control output 21 coupled to a control terminal of the switch 12, providing a supply control signal S_{SC} determining the operative state of the switch 12, more specifically determining the switching moments of the switch 12. The supply control signal S_{SC} is typically a block signal that is either HIGH or LOW. One value of the control output signal Sc, for instance HIGH, results in the switch 12 being closed (i.e. conductive): current flows from the voltage source 11 through the inductor 13 and the LED arrangement 3 back to the voltage source, while the current magnitude increases with time. The inductor 13 is being charged. The other value of the supply control signal S_{SC}, for instance LOW, results in the switch 12 being open (i.e. non-conductive). The inductor 13 tries to maintain the current, which now flows in the loop defined by the inductor 13, the LED arrangement 3 and the diode 14, while the current magnitude decreases with time. The inductor 13 is being discharged.

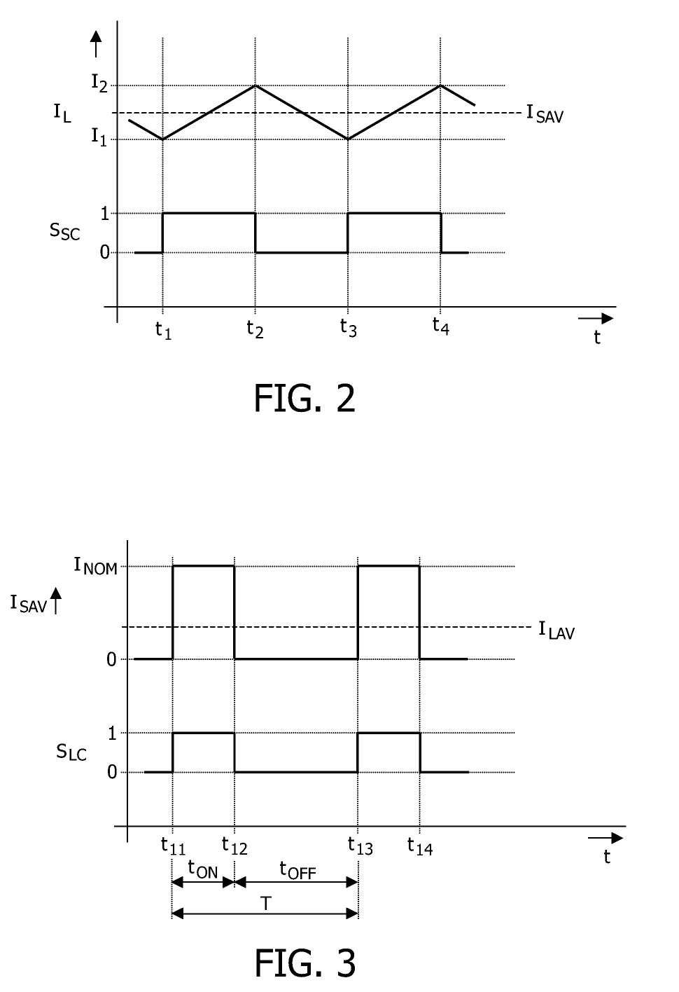

FIG. 2 is a graph illustrating this operation. At times t₁ and t₃, the supply control signal S_{SC} becomes HIGH and the output current I_{L} through the LEDs starts to rise. At times t₂ and t₄, the supply control signal S_{SC} becomes LOW and the output current I_{L} through the LEDs starts to decrease. At times t₁ and t₃, the output current I_{L} has a minimum magnitude I₁, while at times t₂ and t₄, the output current I_{L} has a maximum magnitude I₂. The short term average output current I_{SAV} is a value midway between I₁ and I₂. By increasing/decreasing the duty cycle of the supply control signal S_{SC}, the short term average output current I_{SAV} can be increased/decreased. In this respect, the phrase “short term average” is used to indicate an average over a signal period from t₁ to t₃.

The driver circuit 1 further comprises a current sensor 25, in the exemplary embodiment of FIG. 1 implemented as a resistor connected in series with the LED arrangement 3 between the second output terminal 2b and mass. The LED current I_{L} results in a voltage drop V₂₅ over the current sense resistor 25 proportional to the LED current I_{L}. The voltage V₂₅ constitutes a current measuring signal, which is provided to the controller 20 at a current sense input 22. At a reference input 27, the supply controller 20 receives a reference signal V_{REF-NOM} from a reference source 28, which reference signal V_{REF-NOM} indicates the target value of the short term average current I_{SAV}. The controller 20 compares the current measuring signal V₂₅ with the reference signal V_{REF-NOM}. Based on this comparison, the controller 20 generates its supply control signal S_{SC}. If the current measuring signal V₂₅ indicates that the LED current I_{L} is too high/low, the controller 20 will amend the timing of the supply control signal S_{SC} such that the duty cycle is decreased/increased. The threshold voltage is set to such level that the resulting short term average current I_{SAV} has a predetermined, nominal value I_{NOM}, adapted to the LEDs of the arrangement 3.

The circuit 1 is capable of selectively operating in one of at least two modes. A first mode will be indicated as full intensity mode. In this mode, the LED current is generated continuously, so that the LEDs continuously emit light at full intensity with a color meeting design specifications.

A second mode will be indicated as reduced brightness mode. In this mode, the LED current is generated intermittently, so that the LEDs are alternatively ON and OFF. During the ON periods, the short term average current I_{SAV} has the nominal value I_{NOM}, and the light has the same intensity and color as during the full intensity mode. During the OFF periods, the lamp current is zero and the LEDs emit no light.

For being able to execute this reduced brightness mode, the driver circuit 1 further comprises a second controllable switch 30, for example a transistor, arranged in series with the LED arrangement 3 and the sense resistor 25, and controlled by a mode controller 50. This second controllable switch 30 will also be indicated as lamp switch. The mode controller 50 has a control output 56, coupled to a control input of the lamp switch 30, for providing a lamp switch control signal S_{LC}. FIG. 3 is a graph, comparable to FIG. 2 but at a larger time scale, illustrating this mode of operation. The FIG. shows that the lamp switch control signal S_{LC} can have two values, indicated as 1 and 0 or HIGH and LOW. Between times t₁₁ and t₁₂, the lamp switch control signal S_{LC} is HIGH, resulting in the switch 30 being closed (conductive). Between times t₁₂ and t₁₃, the lamp switch control signal S_{LC} is LOW, resulting in the switch 30 being open (non-conductive). The upper half of this graph illustrates the resulting current shape; more particularly, the graph shows the short term average current I_{SAV} as a function of time. During an ON period, i.e. from time t₁₁ to t₁₂, the short term average current I_{SAV} has the nominal value I_{NOM}, whereas during an OFF period, i.e. from time t₁₂ to t₁₃, the short term average current I_{SAV} is zero. The ON period will also be indicated as pulse, having a pulse duration t_{ON} equal to (t₁₂−t₁₁). The OFF period will also be indicated as pulse pause, having a pause duration t_{OFF} equal to (t₁₃−t₁₂). The combination of pulse and pause defines the current period, having a duration T equal to (t₁₃−t₁₁). A duty cycle Δ is defined as Δ=t_{ON}/T.

A long term average current I_{LAV} is defined as the average of the short term average current I_{SAV} over the current period. It should be clear that the long term average current I_{LAV} relates to the short term average current I_{SAV} according to the following formula:

I_{LAV}=Δ·I_{SAV}

Similarly, the brightness (average light intensity) of the light output of the LED arrangement 3 is reduced, for which reason this mode is indicated as reduced brightness mode.

The mode controller 50 has two mode selection inputs 53 and 54, receiving two mode selection signals S_{T} and S_{B}, respectively. Each mode selection signal can have one of two values, indicated as HIGH and LOW. The controller 50 is responsive to the mode selection signals S_{T} and S_{B} to select its operative mode, as follows. If both signals are LOW, the controller is in an OFF mode; the lamp switch control signal S_{LC} is continuously LOW, the lamp current is continuously zero, the LEDs are continuously OFF. If the second mode selection signal S_{B} is ON, irrespective of the value of the first mode selection signal S_{T}, the mode controller 50 operates in its full intensity mode. If the second mode selection signal S_{B} is OFF and the first mode selection signal S_{T} is ON, the mode controller 50 operates in its reduced brightness mode. Thus, the system is suitable for operation as rear light unit in a car, where the first mode selection signal S_{T} is provided by the light switch while the second mode selection signal S_{B} is provided by the brake pedal.

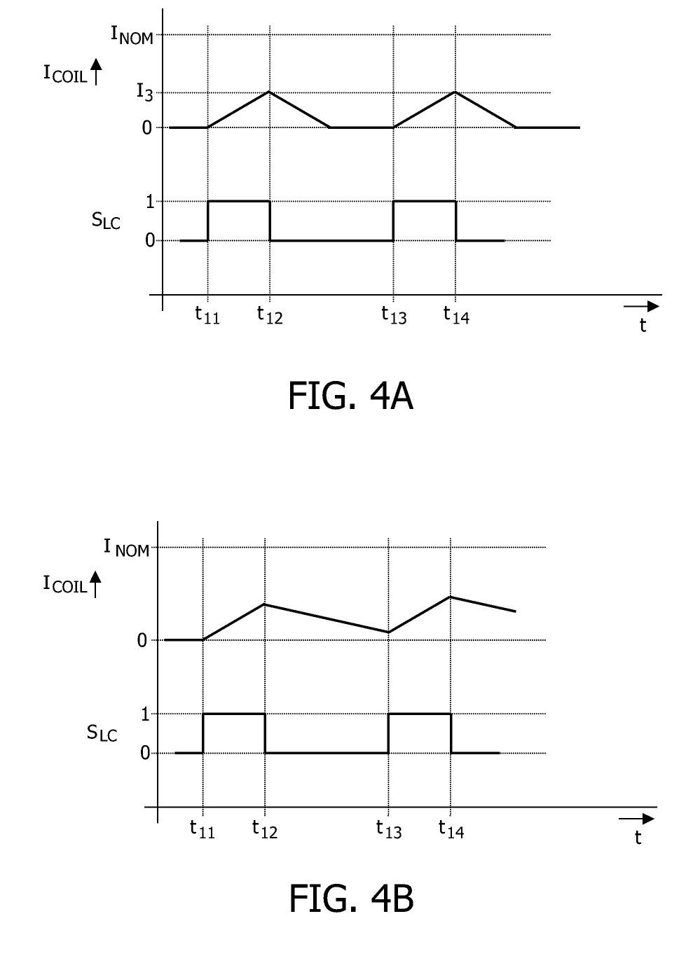

The operation of the driver described above with reference to FIG. 3 is the desired operation. It is implemented relatively easily if the power supply 10 is a fast source: in that case, opening the switch 30 will immediately interrupt the current path from the supply 10 to the LEDs 3 and a current flow is inhibited, while closing the switch will immediately enable the current flow again. However, a problem occurs if the power supply 10 is a slow source. In the context of the present invention, a power supply will be indicated as being “slow” in case it is not capable of having its output current rise from zero to nominal current I_{NOM} within one pulse duration. This situation is illustrated in FIG. 4A, which is a graph having a time scale comparable to FIG. 3. During a pulse from time t₁₁ to time t₁₂, the current increases, with an increase rate comparable to the increase rate illustrated in FIG. 2 from time t₁ to time t₂. During a pause from time t₁₂ to time t₁₃, the current decreases, with a decrease rate comparable to the decrease rate illustrated in FIG. 2 from time t₂ to time t₃. At time t₁₃, the current starts increasing again, but the current in inductor 13 may have reached zero before time t₁₃. The above process is repeated for each current pulse, with the lamp current only reaching a value I₃ much lower than I_{NOM}. In this manner, the lamp current never reaches the desired value I_{NOM}, and consequently the long term average I_{LAV} never reaches its target value.

In a situation where the decrease rate is less than the increase rate, illustrated in FIG. 4B, the decreasing current is still above zero at time t13 when the next pulse begins. Then, after each pulse, the current has increased somewhat with respect to the previous pulse, and slowly the LED current is crawling towards the nominal current I_{NOM}. Likewise, the long term average I_{LAV} is slowly crawling towards its target value. It may take several pulse periods before finally the long term average I_{LAV} has reached its target value.

The present invention is aiming at reducing the above problem of a slow power supply. According to a first aspect of the present invention, the current decrease rate is reduced. This is done by making the converter 10 inactive. To this end, the supply controller 20 has a disable input 26 also receiving the switch control signal S_{LC} from the mode controller 50. If the switch control signal S_{LC} is HIGH, the converter 10 is active, as explained above. If the switch control signal S_{LC} is LOW, the converter 10 is inactive, i.e. the supply controller 20 makes its supply control signal S_{SC} continuously LOW, so that switch 12 is not switching any more. As a result, the condition of the converter 10 is “frozen” at the beginning of a pause (t₁₂, t₁₄, etc), its energy being stored in the capacitor 15.

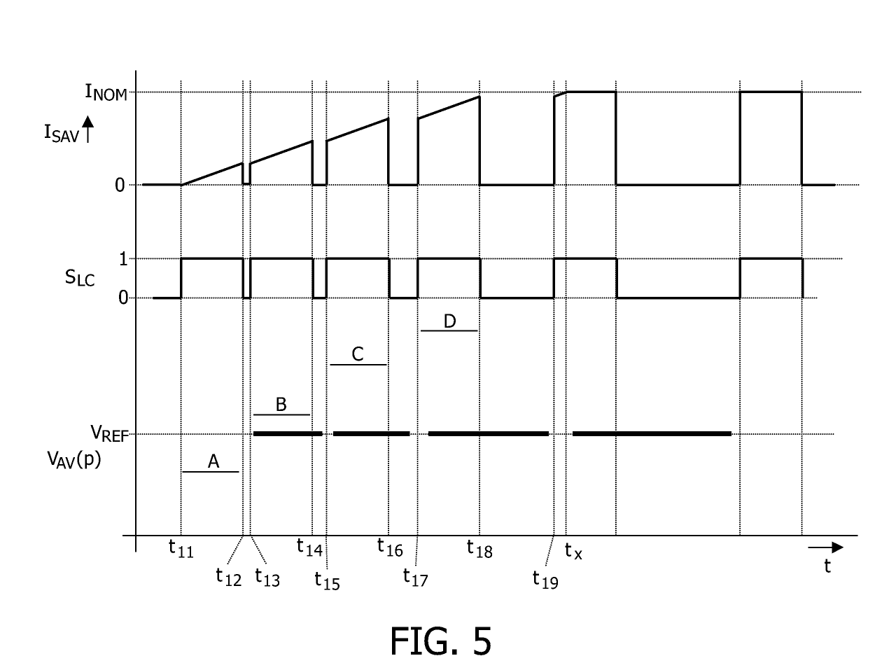

The fact that the converter 10 hardly looses its energy during the pulse pause has an important advantage. During the pulse pause, the output current is of course zero, but the converter 10 maintains a current potential so that, at the start of a next current pulse, it is capable of providing almost the same current intensity as at the end of the previous current pulse, as illustrated in FIG. 5. With each current pulse, the current starts increasing as from the magnitude at the end of the previous pulse, until, after a few pulses, the nominal current magnitude I_{NOM} has been reached.

According to a second aspect of the present invention, also illustrated in FIG. 5, the mode controller 50 takes the current sense signal V₂₅, received at a sense input 52, and calculates a pulse average value V_{AV}(p) over the pulse duration (from t₁₁ to t₁₂). At a reference input 57, the mode controller 50 receives a reference signal V_{REF} from a reference source 40, which reference signal V_{REF} indicates the target value of the long term average current I_{LAV}. If at the end of a pulse, i.e. on time t₁₂, it appears that the pulse average value V_{AV}(p), indicated by line segment A, is lower than the reference signal V_{REF}, the mode controller 50 starts a new pulse as soon as possible (i.e. the pulse pause duration t₁₃−t₁₂ is as small as possible). It may be that the mode controller 50 is capable of making the pulse pause duration to be virtually equal to zero. It may also be that the pulse pause duration at least has a certain minimum duration.

If at the end of a pulse, i.e. on time t₁₄, t₁₆, t₁₈, it appears that the pulse average value V_{AV}(p), indicated by line segments B, C, D, is above V_{REF}, the controller 20 calculates a pause duration (t₁₅−t₁₄), (t₁₇−t₁₆), (t₁₉−t₁₈), such that the current average over the entire period, indicated by the thick line segments, is equal to V_{REF}. The pause duration t_{PAUSE} can be calculated according to

$${t}_{PAUSE} = \frac{{V}_{AV} ( p ) - {V}_{REF}}{{V}_{REF}} \cdot {t}_{PULSE}$$

wherein t_{PULSE} indicates the pulse duration.

Thus, while it can be seen in FIG. 5 that the lamp current I_{SAV} during the pulses is slowly rising until finally reaching the nominal value I_{NOM} at time t_{X}, the pulse pauses are increasing in length such that the average lamp current I_{LAV}, averaged over the entire period, is already at the target value after the second pulse, on time t₁₄.

It is noted that the mode controller 50 preferably sets the pause duration t_{PAUSE} to be equal to the value calculated by the above formula. However, depending on the system, it may be that the mode controller 50 is only capable of setting the pause duration t_{PAUSE} to be equal to certain predetermined discrete values. In that case, the mode controller 50 will select a discrete value as close to the calculated value as possible. In any case, the mode controller 50 will increase the pause duration during the start up procedure, with the effect that, at the beginning of the start up procedure, when the actual current is still below the nominal current, the long term average already reaches the target value relatively early.

It should be clear to a person skilled in the art that the present invention is not limited to the exemplary embodiments discussed above, but that several variations and modifications are possible within the protective scope of the invention as defined in the appending claims.

For instance, in the illustrative embodiment of FIG. 1, the two controllers 20 and 50 have been described as separate controllers. It is however, also possible that these two controllers are integrated. Further, instead of receiving the switch control signal S_{LC} at its enable/disable input 26, it is possible that the supply controller 20 receives different signal which has a timing slightly differing from the timing of the switch control signal S_{LC}, allowing the supply controller 20 to switch slightly earlier or slightly later than the switch 30, as desired.

Further, in the above the invention has been described for an embodiment where the pulse duration was kept constant and the pause duration was adapted; as a result, the pulse frequency will change. It is, however, also possible to achieve duty cycle variation in another way, for instance by keeping the pause duration constant and adapting the pulse duration, or by varying both durations such that the frequency is kept constant.

Further, in the above the invention has been described for an embodiment where the supply controller 20 is discussed as being external of the supply 10. It is, however, also possible that the supply controller 20 is integrated in the supply, in which case the supply can be seen as a black box with an enable/disable input 26.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. A drive circuit for driving a load, the circuit comprising:
(i) an output for connecting the load;
(ii) a power supply for supplying at the output an output current (IL);
(iii) a current sensor for generating a current sense signal (V₂₅) representing the output current (IL);
(iv) a supply controller for controlling the power supply, the supply controller having a current sense input receiving the current sense signal (V₂₅); wherein the supply controller has a supply control output coupled to the power supply, the supply controller being configured to generate a supply control signal (Ssc) for the power supply;
(v) a reference source for generating a reference value (VREF-NOM); wherein the supply controller has a reference input receiving the reference value (VREF-NOM), the supply controller being configured to compare the received current sense signal (V₂₅) with the reference value (VREF-NOM), and, depending on the outcome of the comparison, to generate its supply control signal (Ssc) for adjusting the output current (IL) accordingly;
(vi) a controllable switch in series with the output;
(vii) a mode controller for controlling the controllable switch, the mode controller having a current sense input receiving the current sense signal (V₂₅), the mode controller having a switch control output coupled to a control input of the switch, the mode controller being configured to generate a switch control signal (SLC) for the switch on the basis of the received current sense signal (V₂₅); wherein the mode controller is capable of operating in a reduced brightness mode, in which the mode controller generates the switch control signal (SLC) for the switch for alternatively opening and closing the switch such as to define current pulses and pulse pauses; wherein the supply controller has a disable input receiving a disable signal having a timing equal to or slightly differing from the timing of the switch control signal (SLC), and wherein the supply controller is configured, responsive to the disable signal, to activate or inactivate the power supply.

2. The drive circuit according to claim 1, wherein the mode controller is configured, on start up, to generate the switch control signal (SLC) with a relatively high duty cycle and to gradually decrease the duty cycle over time.

3. The drive circuit according to claim 1, wherein the mode controller is configured, at the end of a current pulse, to calculate, on the basis of the received current sense signal (V₂₅), an average value averaged over the pulse duration, to compare this average value with a reference value (VREF), and, depending on the outcome of the comparison, to calculate a duration for the next pulse pause.

4. The drive circuit according to claim 3, wherein the mode controller is configured, if said average value is larger than said reference value (VREF), to calculate the duration for the next pulse pause such that an average value averaged over the entire pulse period is equal to the reference value (VREF).

5. The drive circuit according to claim 3, wherein the mode controller is configured, if said average value is lower than the reference value (VREF), to set the duration for the next pulse pause to a relatively low value.

6. The drive circuit according to claim 3, wherein the pulse duration is constant.

7. The drive circuit according to claim 1, wherein the mode controller comprises at least a first mode selection input (53) for receiving a first mode selection signal (ST), and wherein the mode controller is selectively operating in said reduced brightness mode in response to the first mode selection signal (ST).

8. The drive circuit according to claim 7, wherein the mode controller further comprises a second mode selection input (54) for receiving a second mode selection signal (SB), and wherein the mode controller is selectively operating in said reduced brightness mode in response to the first mode selection signal (ST) having a first predetermined value (ON) and the second mode selection signal (SB) having a second predetermined value (OFF).

9. The drive circuit according to claim 8, wherein the mode controller is further capable of operating in a full intensity mode, in which the mode controller generates its switch control signal (SLC) for the switch for continuously keeping the switch closed (conductive); and wherein the mode controller is selectively operating in said full intensity mode in response to the second mode selection signal (SB) having a predetermined value (ON) differing from said second predetermined value (OFF), irrespective of the value of the first mode selection signal (ST).

10. A lighting unit, comprising a LED arrangement and a drive circuit according to claim 1 for driving the LED arrangement.

11. (canceled)
